(19) United States
(12) Patent Application Publication
(10) Pub. No.: US 2026/0351893 A1
(43) Pub. Date: Nov. 5, 2026

(54) WIRING MEMBER

(71) Applicant: Sumitomo Wiring Systems, Ltd., Yokkaichi-shi, Mie (JP)

(72) Inventors: Megumi YAMAO, Yokkaichi-shi, Mie (JP); Toshinari KOBAYASHI, Yokkaichi-shi, Mie (JP); Hidetsugu KUBOTA, Yokkaichi-shi, Mie (JP); Yukitoshi TERASAKA, Yokkaichi-shi, Mie (JP); Hiroyuki KOYANO, Yokkaichi-shi, Mie (JP); Lin WEI, Yokkaichi-shi, Mie (JP)

(73) Assignee: Sumitomo Wiring Systems, Ltd., Yokkaichi-shi, Mie (JP)

(21) Appl. No.: 19/119,465

(22) PCT Filed: Sep. 26, 2023
(86) PCT No.: PCT/JP2023/034965

§ 371 Date: Apr. 9, 2025

(30) Foreign Application Priority Data
Oct. 11, 2022 (JP) 2022-162915

(51) Int. Cl. H01R 13/52; H01B 7/282; H01R 13/506; H01R 24/28; H02G 15/04

(52) U.S. Cl. CPC H01R 13/5208; H01B 7/282; H01R 13/506; H01R 24/28; H02G 15/043

(57) ABSTRACT

A wiring member includes: a molded part; an electric wire that includes a first section covered by the molded part and a second section connected to the first section and extending outside of the molded part; and a waterproof plug that is provided outside of the molded part and covers an annular boundary line that is a boundary with the electric wire on an outer surface of the molded part. The waterproof plug includes a first contact part that contacts the outer surface of the molded part in a watertight manner on an outer peripheral side of the annular boundary line, and a second contact part that contacts an outer periphery of the electric wire in a watertight manner in the second section.

### CROSS-REFERENCE TO RELATED APPLICATIONS

This application is the U.S. national stage of PCT/JP2023/034965 filed on Sep. 26, 2023, which claims priority of Japanese Patent Application No. JP 2022-162915 filed on Oct. 11, 2022, the contents of which are incorporated herein.

### TECHNICAL FIELD

The present disclosure relates to a wiring member.

### BACKGROUND

JP 2020-25416A discloses a water stop structure for a cable that has an electric wire and a sheath covering the outer periphery of the electric wire. The water stop structure for a cable includes a waterproof plug that is arranged on the outer periphery of the electric wire exposed from the sheath, a resin member through which the electric wire is inserted and in which an insertion hole for storing the waterproof plug is formed, and a molded body that is made of a resin and covers a part of the sheath and at least a part of the resin member.

A wiring member of the present disclosure is a wiring member including; a molded part; an electric wire that includes a first section covered by the molded part and a second section connected to the first section and extending outside of the molded part; and a waterproof plug that is provided outside of the molded part and covers an annular boundary line that is a boundary with the electric wire on an outer surface of the molded part, wherein the waterproof plug includes a first contact part that contacts the outer surface of the molded part in a watertight manner on an outer peripheral side of the annular boundary line, and a second contact part that contacts an outer periphery of the electric wire in a watertight manner in the second section.

### SUMMARY

In the water stop structure for a cable described in JP 2020-25416A, the waterproof plug and the resin member need to be insert parts as well as the cable in molding the molded body.

In view of this, an object of the present disclosure is to provide a technology for suppressing intrusion of water through a gap between the molded part and the electric wire without using a waterproof plug as an insert part.

### Advantageous Effects

According to the present disclosure, it is possible to provide a technology for suppressing intrusion of water through a gap between the molded part and the electric wire without using a waterproof plug as an insert part.

### BRIEF DESCRIPTION OF DRAWINGS

FIG. 1 is a plan view of a wiring member according to a first embodiment.

FIG. 2 is a cross-sectional view taken along line II-II in FIG. 1.

FIG. 3 is an exploded perspective view of the wiring member.

FIG. 4 is a plan view of a wiring member according to a second embodiment.

FIG. 5 is a cross-sectional view taken along line V-V in FIG. 4.

FIG. 6 is an exploded perspective view of the wiring member.

### DETAILED DESCRIPTION OF PREFERRED EMBODIMENTS

First, embodiments of the present disclosure will be listed and described.

A wiring member of the present disclosure is as follows.

In a first aspect, a wiring member includes: a molded part; an electric wire that includes a first section covered by the molded part and a second section connected to the first section and extending outside of the molded part; and a waterproof plug that is provided outside of the molded part and covers an annular boundary line that is a boundary with the electric wire on an outer surface of the molded part. The waterproof plug includes a first contact part that contacts the outer surface of the molded part in a watertight manner on an outer peripheral side of the annular boundary line, and a second contact part that contacts an outer periphery of the electric wire in a watertight manner in the second section.

According to the wiring member of the first aspect, the first contact part suppresses water outside of the first contact part from flowing along the outer surface of the molded part and reaching the annular boundary line. In addition, the second contact part suppresses water outside of the second contact part from flowing along the outer surface of the electric wire and reaching the annular boundary line. Accordingly, the waterproof plug provided outside of the molded part suppresses intrusion of water into the annular boundary line, and thus it is possible to suppress intrusion of water through a gap between the molded part and the electric wire without using the waterproof plug as an insert part.

In a second aspect, in the wiring member of the first aspect, the first contact part and the outer surface may be aligned along an extending direction of the electric wire. Accordingly, the direction in which the first contact part contacts the outer surface of the molded part and the direction in which the second contact part contacts the outer periphery of the electric wire are different from each other.

In a third aspect, the wiring member of the second aspect may further include a retainer that maintains a contact state of the waterproof plug with the molded part and the electric wire, the retainer may include a fixed part to the molded part and a holding part that holds the waterproof plug, and the first contact part may be pressed by the retainer against the molded part along the extending direction. This makes it easier to maintain an appropriate contact state of the waterproof plug with the electric wire and the molded part.

In a fourth aspect, in the wiring member of the second or the third aspect, a plurality of the electric wires may be provided, a plurality of through holes may be formed in the waterproof plug formed in a plate shape, the electric wires may pass through the plurality of through holes, and an inner peripheral surface of each of the plurality of through holes may be the second contact part. This suppresses an increase in the number of parts constituting the wiring member.

In a fifth aspect, in the wiring member of the first aspect, the molded part may include a main body and a cylindrical part that protrudes from the main body in an extending direction of the electric wire to cover the outer periphery of the electric wire, and the first contact part may contact an outer periphery of the cylindrical part. Accordingly, the direction in which the first contact part contacts the molded part and the direction in which the second contact part contacts the electric wire are the same.

In a sixth aspect, the wiring member of the fifth aspect may further include a retainer that maintains the contact state of the waterproof plug with the molded part and the electric wire, the retainer may include a fixed part to the molded part and a holding part that holds the waterproof plug, and the waterproof plug may be stored in the holding part. This makes it easier to maintain the appropriate contact state of the waterproof plug with the electric wire and the molded part.

In a seventh aspect, in the wiring member of the sixth aspect, a lock receiving part may be provided at a base end of the cylindrical part, and the fixed part may have a protruding piece that extends from the holding part toward the main body along the extending direction, and a locking part that is provided on the protruding piece and locks into the lock receiving part. This suppresses the retainer from becoming larger than the molded part in the radial direction of the electric wire.

In an eighth aspect, in the wiring member according to any one of the first through the seventh aspects, a terminal may be provided at an end of the first section of the electric wire, a sheath may be provided in the second section of the electric wire, the molded part may include a part that serves as a connector housing for holding the terminal, and an end of the sheath may be separate from the waterproof plug and the retainer along the extending direction. Accordingly, even if the molded part serves as a connector housing, the waterproof plug can suppress intrusion of water through a gap between the molded part and the electric wire, thereby suppressing water from splashing on the terminal. In addition, it is easy to provide the molded part at the end of the electric wire with the electric wire passed through the waterproof plug and the retainer.

Specific examples of a wiring member in the present disclosure will be described below with reference to the drawings. It should be noted that the present disclosure is not limited to these examples, but rather is indicated by the scope of claims, and is intended to include all modifications within a meaning and scope equivalent to the scope of claims.

### First Embodiment

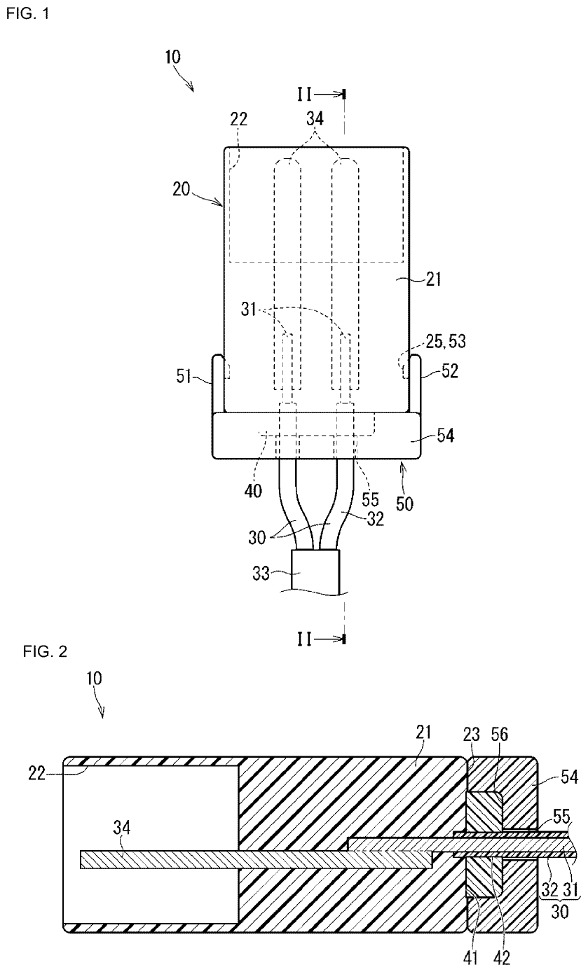

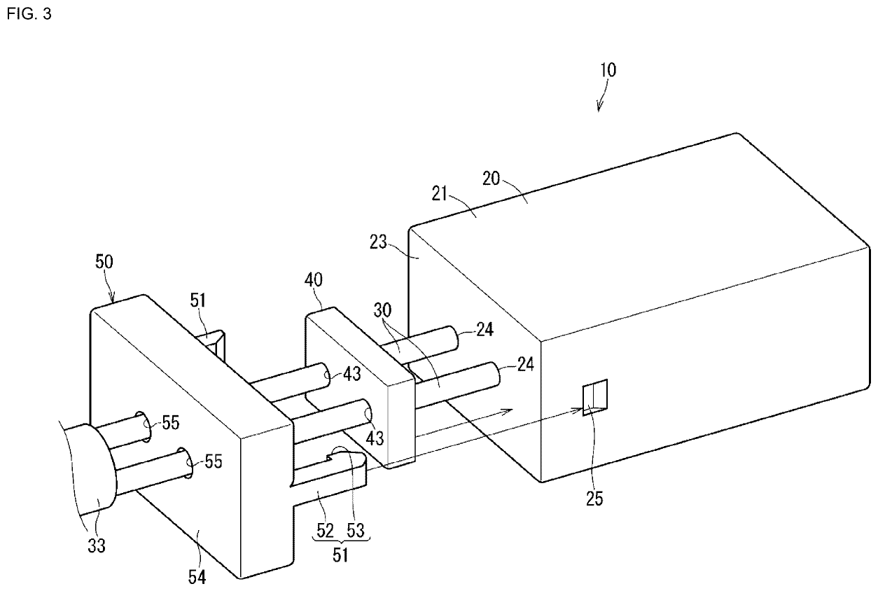

A wiring member according to a first embodiment will be described below. FIG. 1 is a plan view of a wiring member 10 according to the first embodiment. FIG. 2 is a cross-sectional view taken along line II-II in FIG. 1. FIG. 3 is an exploded perspective view of the wiring member 10.

The wiring member 10 includes a molded part 20, an electric wire 30, and a waterproof plug 40. The wiring member 10 here further includes a retainer 50. The wiring member 10 connects devices mounted in a vehicle to each other, for example. One end of the wiring member 10 here is connected to a device arranged in the suspension of the vehicle. Such a device is a wheel speed sensor for an electric parking brake (EPB) or an antilock brake system (ABS), for example.

The molded part 20 covers the electric wire 30. The molded part 20 is formed by insert molding using a metal mold with the electric wire 30 as an insert part. The molded part 20 is an insulator. For example, the molded part 20 is made of a resin such as nylon. The molded part 20 includes a main body 21 and lock receiving parts 25. The main body 21 covers the electric wire 30. The lock receiving parts 25 are used for fixing to the retainer 50.

The electric wire 30 includes a first section and a second section. The first section is covered by the molded part 20. The second section is connected to the first section. The second section extends outside of the molded part 20. The electric wire 30 is a covered electric wire including a core wire 31 and a covering layer 32. The core wire 31 is a conductor. The core wire 31 is made of a metal such as copper, copper alloy, aluminum, or aluminum alloy, for example. The covering layer 32 is an insulator. For example, the covering layer 32 is made of a resin such as polyethylene. A plurality of (here, two) electric wires 30 here are covered by one molded part 20. A sheath 33 here is provided on the second sections of the electric wires 30. The sheath 33 is formed by extrusion molding of a resin or the like around the plurality of electric wires 30. The sheath 33 is made of a resin such as polyurethane, for example.

The main body 21 is provided at ends of the electric wires 30 and serves as a connector housing. The main body 21 here is formed in the shape of a rectangular parallelepiped. The main body 21 has a connection port 22 to be connected to a mating connector, on one outer surface thereof. In the present disclosure, among the outer surfaces of the main body 21, the surface with the connection port 22 is referred to as front surface. The electric wires 30 extend from an outer surface of the main body 21 different from the front surface. The electric wires 30 here extend from a rear surface 23 opposite to the front surface. The electric wires 30 may extend from a side surface of the main body 21 different from the front surface and the rear surface 23.

Terminals 34 are connected to ends of the first sections of the electric wires 30. The mode of connection between the electric wire 30 and the terminal 34 is not particularly limited and may be soldering, crimping, welding, or the like. The connection parts between the electric wires 30 and the terminals 34 are covered by the main body 21. The terminals 34 are also insertion parts. The main body 21 as a connector housing holds the plurality of terminals 34 in predetermined alignment. The electric wires 30 and the terminals 34 are connected to each other to form terminal-equipped electric wires, which are placed in the molding die for the molded part 20.

The terminals 34 are male terminals. The inside of the connection port 22 is a space in which the tips of a plurality of male terminals are exposed. A part of the main body 21 surrounding the space in the connection port 22 is also called a hood part. Another connector housing that holds a female terminal is inserted into the connection port 22, and the male terminal and the female terminal are connected.

The lock receiving parts 25 are provided on outer surfaces of the main body 21. The lock receiving parts 25 are provided on a pair of side surfaces among the outer surfaces of the main body 21. The lock receiving parts 25 are recesses formed by partially recessing the outer surfaces of the main body 21.

Boundary lines between the molded part 20 and the electric wires 30 appear on the outer surface (here, the rear surface 23) of the molded part 20. The boundary lines extend in an annular shape along the outer peripheral edges of the electric wires 30. In the present disclosure, the boundary lines are referred to as annular boundary lines 24. A contact surface to a first contact part 41 is provided on the rear surface 23 of the molded part 20 on the outer peripheral sides of the annular boundary lines 24.

The resin of the molded part 20 and the resin of the coating layer 32 are different types of resins. For example, the molded part 20 is made of nylon, and the coating layer 32 is made of polyethylene. Although the molded part 20 and the coating layer 32 are in contact macroscopically, they are not completely fused together microscopically, and there may be generated a gap through which water can intrude between the molded part 20 and the coating layer 32. The waterproof plug 40 is provided to suppress intrusion of water through the gap.

The waterproof plug 40 is provided outside of the molded part 20. The waterproof plug 40 is not an insert part in the molded part 20, but is externally attached to the molded part 20 after molding. The waterproof plug 40 covers the annular boundary lines 24 and contacts both the molded part 20 and the electric wires 30 around the annular boundary lines 24. The waterproof plug 40 includes the first contact part 41 and a second contact part 42. The first contact part 41 contacts the outer surface of the molded part 20 in a watertight manner on the outer peripheral side of the annular boundary lines 24. The second contact part 42 contacts the outer peripheries of the electric wires 30 in the second section in a watertight manner.

In the present disclosure, contacting in a watertight manner refers to contacting so as not to generate a gap through which water can intrude at the contact part. As described above, macroscopically, the molded part 20 and the electric wire 30 are in contact with each other, but microscopically, a gap through which water can intrude may be formed between the molded part 20 and the electric wires 30. There is no gap between the first contact part 41 and the molded part 20, or even if there is a gap, the gap is smaller than the gap between the molded part 20 and the electric wires 30, and thus the intrusion of water can be suppressed. Similarly, there is no gap between the second contact part 42 and the electric wires 30, or even if there is a gap, the gap is smaller than the gap between the molded part 20 and the electric wires 30, and thus the intrusion of water can be suppressed.

The waterproof plug 40 is formed in a plate shape. The waterproof plug 40 is made of an elastic material such as rubber. The waterproof plug 40 has a through hole 43. The through hole 43 penetrates the waterproof plug 40 in the thickness direction. The part around the through hole 43 in the main surface of the waterproof plug 40 constitutes the first contact part 41. The first contact part 41 and the contact surface on the outer surface of the molded part 20 are aligned along the extending direction of the electric wire 30 (the protruding direction of the electric wire 30 from the molded part 20). The inner peripheral surface of the through hole 43 in the waterproof plug 40 constitutes the second contact part 42. The second contact part 42 and the contact surface on the outer surface of the electric wire 30 are aligned in the radial direction. Both the electric wire 30 and the through hole 43 are circular in shape, and the inner diameter of the through hole 43 is the same as or smaller than the outer diameter of the electric wire 30.

The waterproof plug 40 here has a plurality of through holes 43. The electric wires 30 pass through the plurality of through holes 43. One waterproof plug 40 is in contact with the plurality of electric wires 30. The inner peripheral surface of each of the plurality of through holes 48 constitutes the second contact part 42.

The first contact part 41 may be provided so as to surround each of the plurality of through holes 43. That is, a plurality of first contact parts 41 may be provided in correspondence with the plurality of through holes 43. One first contact part 41 may be provided so as to surround all of the plurality of through holes 43. That is, only one first contact part 41 may be provided for one waterproof plug 40 with a plurality of through holes 43.

The flat surfaces of the first contact part 41 and the rear surface 23 are in contact with each other. At least one of the first contact part 41 and the rear surface 23 may have an annular convex part 44.

The retainer 50 maintains the contact state of the waterproof plug 40 with the molded part 20 and the electric wires 30. The retainer 50 includes a fixed part 51 and a holding part 54. The fixed part 51 is fixed to the molded part 20. The holding part 54 holds the waterproof plug 40. The first contact part 41 is pressed by the retainer 50 against the molded part 20 along the extending direction of the electric wires 30. The waterproof plug 40 may be compressed by the retainer 50 along the extending direction of the electric wires 30. The retainer 50 and the waterproof plug 40 may be in contact with each other in a watertight manner, or may not be in contact with each other.

The fixed part 51 has a protruding piece 52 and a locking part 53. The protruding piece 52 extends from the holding part 54 toward the molded part 20 along the extending direction. A pair of protruding pieces 52 are provided here. The locking part 53 is provided at each of the protruding pieces 52. The locking parts 53 lock into the lock receiving parts 25. The locking parts 53 are formed in a convex shape, and the lock receiving parts 25 are formed in a concave shape. The locking parts 53 may be formed in a concave shape, and the lock receiving parts 25 may be formed in a convex shape.

The holding part 54 is formed in a plate shape. The holding part 54 has insertion holes 55. The insertion holes 55 penetrate the holding part 54 in the thickness direction. The number of insertion holes 55 is the same as the number of electric wires 30. The electric wires 30 penetrate the plurality of insertion holes 55. The inner diameter of the insertion holes 55 may be the same as or larger than the outer diameter of the electric wires 30.

The holding part 54 is formed in a plate shape larger than the waterproof plug 40. The waterproof plug 40 is sandwiched between the molded part 20 and the holding part 54. The holding part 54 has a positioning concave part 56. The positioning concave part 56 is formed to a size corresponding to the waterproof plug 40. The waterproof plug 40 fits in the positioning concave part 56. The insertion holes 55 are formed in the bottom of the positioning concave part 56. However, the holding part 54 may not have the positioning concave part 56.

The surface of the holding part 54 that is in contact with the waterproof plug 40 (here, the bottom surface of the positioning concave part 56) is a flat surface. The holding part 54 may have the annular convex part 44 on the surface that is in contact with the waterproof plug 40.

An end of the sheath 38 is separate from the waterproof plug 40 and the retainer 50. For example, the molded part 20 is formed at ends of the electric wires 30 in a state where the electric wires 30 are passed through the waterproof plug 40 and the retainer 50. The molded part 20 is molded in a state where the waterproof plug 40 and the retainer 50 are retracted to the other end side of the electric wires 30 so as not to enter the molding die for the molded part 20.

After the molding of the molded part 20, the waterproof plug 40 and the retainer 50 are moved along the electric wires 30 toward the molded part 20. The waterproof plug 40 contacts the rear surface 23, and the locking parts 53 lock into the lock receiving parts 25, thereby completing the wiring member 10.

Since the end of the sheath 33 is separate from the waterproof plug 40 and the retainer 50, the waterproof plug 40 and the retainer 50 can be easily retracted to the other end side of the electric wires 30. The waterproof plug 40 and the retainer 50 being retracted to the other end side of the electric wires 30 are stopped by the end of the sheath 33, and are difficult to further move toward the other end side beyond the end of the sheath 33. The distance between the end of the sheath 33 and the waterproof plug 40 and the retainer 50 can be set as appropriate according to the lengthwise dimension by which the waterproof plug 40 and the retainer 50 are to be retracted, and the like.

According to the wiring member 10 configured as described above, the first contact part 41 suppresses water outside of the first contact part 41 from flowing along the outer surface of the molded part 20 and reaching the annular boundary lines 24. In addition, the second contact part 42 suppresses water outside of the second contact part 42 from flowing along the outer surfaces of the electric wires 30 and reaching the annular boundary lines 24. Accordingly, the waterproof plug 40 provided outside of the molded part 20 suppresses intrusion of water into the annular boundary lines 24, and thus, even without using the waterproof plug 40 as an insert part, it is possible to suppress intrusion of water through the gaps between the molded part 20 and the electric wires 30.

The first contact part 41 and the outer surface are aligned along the extending direction of the electric wires 30. Accordingly, the direction in which the first contact part 41 contacts the outer surface of the molded part 20 and the direction in which the second contact part 42 contacts the outer peripheries of the electric wires 30 are different from each other.

The wiring member 10 further includes the retainer 50 that maintains the contact state of the waterproof plug 40 with the molded part 20 and the electric wires 30, and the first contact part 41 is pressed by the retainer 50 against the molded part 20 along the extending direction. This makes it easier to maintain the appropriate contact state of the waterproof plug 40 with the electric wires 30 and the molded part 20.

The inner peripheral surface of each of the plurality of through holes 43 serves as the second contact part 42. This suppresses an increase in the number of parts constituting the wiring member 10.

Since the molded part 20 includes a part that serves as a connector housing for holding the terminals 34, even if the molded part 20 serves as a connector housing, the waterproof plug 40 can suppress intrusion of water through the gaps between the molded part 20 and the electric wires 30, thereby suppressing water from being splashed onto the terminals 34. Furthermore, since the end of the sheath 33 is separate from the waterproof plug 40 and the retainer 50, it is easy to provide the molded part 20 at the ends of the electric wires 30 in a state where the electric wires 30 are passed through the waterproof plug 40 and the retainer 50.

### Second Embodiment

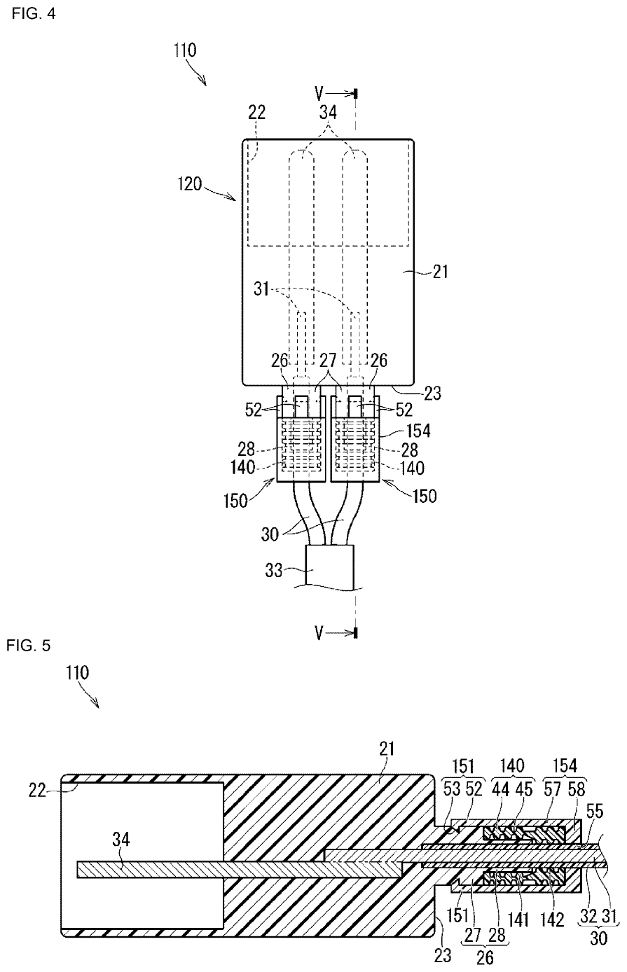

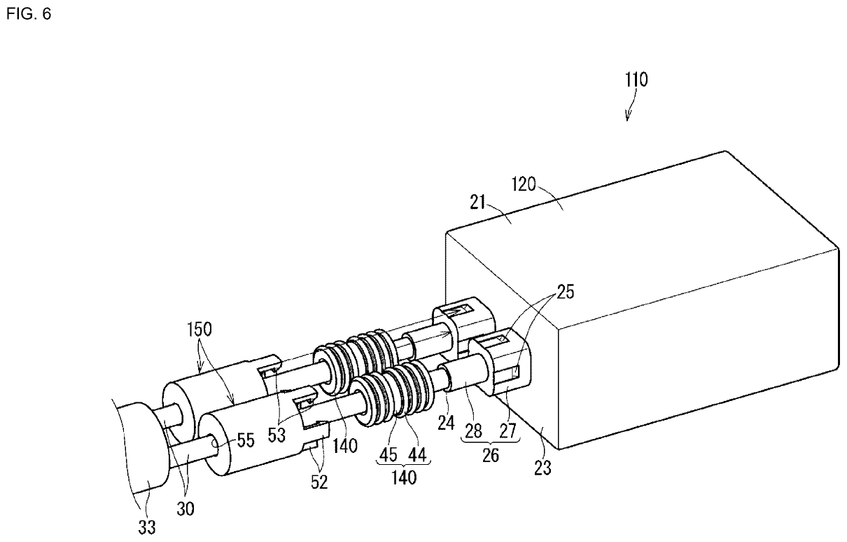

A wiring member according to a second embodiment will be described. FIG. 4 is a plan view of a wiring member 110 according to the second embodiment, FIG. 5 is a cross-sectional view taken along line V-V in FIG. 4. FIG. 6 is an exploded perspective view of the wiring member 110. In the description of the present embodiment, components similar to those described so far are given the same reference signs and descriptions thereof will be omitted.

In the wiring member 110, the shapes of a molded part 120, a waterproof plug 140 and a retainer 150 are different from the shapes of the molded part 20, the waterproof plug 40, and the retainer 50 described above.

The molded part 120 further includes a main body 21, lock receiving parts 25, and cylindrical parts 26. The cylindrical parts 26 protrude from a rear surface 23 of the main body 21 in the extending direction of electric wires 30 to cover the outer peripheries of the electric wires 30. Each cylindrical part 26 has a first cylindrical part 27 and a second cylindrical part 28. The first cylindrical part 27 protrudes from the rear surface 23 of the main body 21. The second cylindrical part 28 protrudes from the leading end of the first cylindrical part 27. The electrical wire 30 protrudes from the leading end surface of the second cylindrical part 28. The annular boundary line 24 is provided on the leading end surface of the second cylindrical part 28. The first cylindrical part 27 is thicker than the second cylindrical part 28. The first cylindrical part 27 is formed in a rectangular cylindrical shape. The cross section of the first cylindrical part 27 here is formed in a square shape. The second cylindrical part 28 is formed in a circular cylindrical shape.

The lock receiving parts 25 are provided not at the main body 21 but at the cylindrical parts 26. The lock receiving parts 25 are provided at the base ends (here, the first cylindrical parts 27) of the cylindrical parts 26. The lock receiving parts 25 are provided on the four faces of each first cylindrical part 27.

The waterproof plug 140 is provided for each electric wire 30. A first contact part 141 contacts the outer periphery of the cylindrical part 26 in a watertight manner. The first contact part 141 here contacts the outer periphery of the second cylindrical part 28 in a watertight manner. Each waterproof plug 140 is formed in a shape in which the first contact part 141 and a second contact part 142 are continuous in the extending direction. The inner peripheral surface and outer peripheral surface of the waterproof plug 140 here are each formed in a shape in which annular convex parts 44 and annular concave parts 45 are alternately continuous in the axial direction. Each annular convex part 44 on the inner peripheral surface and each annular convex part 44 on the outer peripheral surface are provided at the same position in the axial direction. Each annular concave part 45 on the inner peripheral surface and each annular concave part 45 on the outer peripheral surface are provided at the same positions in the axial direction. The annular convex part 44 on the inner peripheral surface of one axial end side part of the waterproof plug 140 serves as the first contact part 141, and the annular convex part 44 on the inner peripheral surface of the other axial end side part of the waterproof plug 140 serves as the second contact part 142.

The outer peripheries of the cylindrical parts 26 are thicker than the outer peripheries of the electric wires 30. In the waterproof plug 40 before being attached to the electric wires 30 and the cylindrical parts 26, the inner diameter of the first contact part 141 and the inner diameter of the second contact part 142 may be different from each other or may be the same. In the waterproof plug 140 before being attached to the electric wires 30 and the cylindrical parts 26, the outer diameter of the first contact part 141 and the outer diameter of the second contact part 142 may be different from each other or may be the same.

A retainer 150 is also provided for each electric wire 30. One waterproof plug 140 is stored in a holding part 154 of one retainer 150.

Each holding part 154 has a cylindrical part 57 and a bottom part 58. The cylindrical part 57 is formed in a circular cylindrical shape. The waterproof plug 140 is stored in the cylindrical part 57. In the cylindrical part 57 here, the cross-sectional shape of the part storing the first contact part 141 and the cross-sectional shape of the part storing the second contact part 142 are the same shape. In the cylindrical part 57, the cross-sectional shape of the part storing the first contact part 141 and the cross sectional shape of the part storing the second contact part 142 may be different from each other, For example, in the cylindrical part 57, the inner diameter of the part storing the first contact part 141 may be larger than the inner diameter of the part storing the second contact part 142. The inner diameter of the cylindrical part 57 is nearly the same as the length of one side of the square of the first cylindrical part 27. The outer diameter of the cylindrical part 57 is nearly the same as the length of the diagonal of the square of the first cylindrical part 27.

Each bottom part 58 is not provided at one end of the cylindrical part 57 (the end on the main body 21 side along the axial direction). The bottom part 58 is provided at the other end of the cylindrical part 57. The bottom part 58 narrows the opening of the cylindrical part 57. The bottom part 58 has one insertion hole 55. The electric wire 30 passes through the insertion hole 55, The one end of the cylindrical part 57 is open larger than the other end of the same. The waterproof plug 40 is stored in the cylindrical part 57 through the opening at the one end of the cylindrical part 57. The waterproof plug 140 is positioned by contacting the bottom part 58. The opening edge at the one end of the cylindrical part 57 contacts the square corner of the first cylindrical part 27. This restricts the movement of the retainer 150 toward the main body 21.

The first contact parts 141 may or may not be compressed by the retainer 150 in the radial direction. The second contact parts 142 may or may not be compressed by the retainer 150 in the radial direction. If each waterproof plug 140 is to be compressed in the radial direction, the inner diameter (inner diameter of the annular convex part 44) of the waterproof plug 140 before compression is preferably formed smaller than the outer diameter of the electric wire 30 and the second cylindrical part 28, and the outer diameter (outer diameter of the annular convex part 44) of the waterproof plug 140 before compression is preferably formed smaller than the inner diameter of the cylindrical part 57. The waterproof plugs 140 may or may not be compressed by the retainer 150 in the axial direction. If each waterproof plug 140 is to be compressed in the axial direction, the axial length of the waterproof plug 140 before compression is preferably formed smaller than the distance between the bottom part 58 and the leading end surface of the first cylindrical part 27 when the retainer 150 is fixed to the cylindrical part 26.

Each fixed part 151 has four protruding pieces 52 that protrude from the holding part 154. Locking parts 53 of the four protruding pieces 52 are locked into corresponding ones of the lock receiving parts 25 on the four sides of the first cylindrical part 27.

In the wiring member 110 configured as described above, as in the wiring member 10, the first contact parts 141 suppresses water outside of the first contact parts 141 from flowing along the outer surface of the molded part 120 and reaching the annular boundary lines 24. In addition, the second contact parts 142 suppresses water outside of the second contact parts 142 from flowing along the outer surfaces of the electric wires 30 and reaching the annular boundary lines 24. Accordingly, the waterproof plugs 140 provided outside of the molded part 120 suppress intrusion of water into the annular boundary lines 24, and thus, even without using the waterproof plugs 140 as insert parts, it is possible to suppress intrusion of water through the gaps between the molded part 120 and the electric wires 30. In addition, even if the molded part 120 serves as a connector housing, the waterproof plugs 140 can suppress intrusion of water through the gaps between the molded part 120 and the electric wires 30, thereby suppressing water from being splashed onto terminals 34. Furthermore, since the end of a sheath 33 is separate from the waterproof plugs 140 and the retainers 150, it is easy to provide the molded part 120 at the ends of the electric wires 30 in a state where the electric wires 30 are passed through the waterproof plugs 140 and the retainers 150.

According to the wiring member 110, each first contact part 141 contacts the outer periphery of the cylindrical part 26. Accordingly, the direction in which the first contact part 141 contacts the molded part 120 and the direction in which the second contact part 142 contacts the electric wire 30 are the same.

The wiring member 110 further includes the retainers 150 that maintain the contact state of the waterproof plugs 140 with the molded part 120 and the electric wires 30, and the waterproof plugs 140 are stored in the holding parts 154. Accordingly, the waterproof plugs 140 are positioned at predetermined positions with respect to the cylindrical parts 26 and the electric wires 30. This makes it easier to maintain the appropriate contact state of the waterproof plugs 140 with the electric wires 30 and the molded part 120.

The lock receiving parts 25 are provided at base ends of each cylindrical part 26, and each fixed part 151 has the protruding pieces 52 that extend from the holding part 154 toward the main body 21 along the extending direction, and the locking parts 53 that are provided on the protruding pieces 52 and lock into the lock receiving parts 25. This suppresses the retainer 150 from becoming larger than the molded part 120 in the radial direction of the electric wire 30.

### Supplementary Remarks

In the first embodiment, one waterproof plug 40 is provided in correspondence with a plurality of electric wires 30, but this is not an essential configuration. As in the second embodiment, a waterproof plug may be provided for each electric wire 30. Similarly, in the first embodiment, one retainer 50 is provided in correspondence with a plurality of electric wires 30, but this is not an essential configuration. As in the second embodiment, a retainer may be provided for each electric wire 30.

In the second embodiment, the waterproof plug 140 is provided for each electric wire 30, but this is not an essential configuration. As in the first embodiment, one waterproof plug may be provided in correspondence with a plurality of electric wires 30. Similarly, in the second embodiment, the retainer 150 is provided for each electric wire 30, but this is not an essential configuration. As in the first embodiment, one retainer may be provided in correspondence with a plurality of electric wires 30.

It has been described above that the number of waterproof plugs 40, 140 and the number of retainers 50, 150 are the same, but this is not an essential configuration. For example, one waterproof plug may be provided in correspondence with a plurality of electric wires 30, and a retainer may be provided for each electric wire 30. Also, for example, a waterproof plug may be provided for each electric wire 30, and one retainer may be provided in correspondence with a plurality of electric wires 30.

The wiring members 10, 110 have been described above as including the retainers 50, 150, but this is not an essential configuration. The wiring member does not necessarily have to include a retainer, The waterproof plugs 40, 140 have been described above as including the first contact part 41, 141 and the second contact part 42, 142 in one member, but this is not an essential configuration. A member including the first contact part 41, 141 and a member including the second contact part 42, 142 may be provided separately.

The molded part 20, 120 have been described above as being provided at the ends of the electric wires 30 and including a part that serves as a connector housing, but this is not an essential configuration. A molded part may be provided at a branch part of a plurality of electric wires 30 and may hold each electric wire 30 in the extending direction.

It has been described above that the sheath 33 is provided in the second sections of the electric wires 30, but this is not an essential configuration. The sheath 33 does not necessarily have to be provided in the second sections of the electric wires 30.

The configurations described above in the embodiments and modifications can be combined as appropriate as long as they are not inconsistent with each other.

1. A wiring member comprising:
a molded part;
an electric wire that includes a first section covered by the molded part and a second section connected to the first section and extending outside of the molded part; and
a waterproof plug that is provided outside of the molded part and covers an annular boundary line that is a boundary with the electric wire on an outer surface of the molded part,
wherein the waterproof plug includes a first contact part that contacts the outer surface of the molded part in a watertight manner on an outer peripheral side of the annular boundary line, and a second contact part that contacts an outer periphery of the electric wire in a watertight manner in the second section.

2. The wiring member according to claim 1, wherein the first contact part and the outer surface are aligned along an extending direction of the electric wire.

3. The wiring member according to claim 2, further comprising a retainer that maintains a contact state of the waterproof plug with the molded part and the electric wire,
wherein the retainer includes a fixed part to the molded part and a holding part that holds the waterproof plug, and
the first contact part is pressed by the retainer against the molded part along the extending direction.

4. The wiring member according to claim 2,
wherein a plurality of the electric wires are provided,
a plurality of through holes are formed in the waterproof plug formed in a plate shape,
the electric wires pass through the plurality of through holes, and
an inner peripheral surface of each of the plurality of through holes is the second contact part.

5. The wiring member according to claim 1,
wherein the molded part includes a main body and a cylindrical part that protrudes from the main body in an extending direction of the electric wire to cover the outer periphery of the electric wire, and
the first contact part contacts an outer periphery of the cylindrical part.

6. The wiring member according to claim 5, further comprising a retainer that maintains a contact state of the waterproof plug with the molded part and the electric wire,
wherein the retainer includes a fixed part to the molded part and a holding part that holds the waterproof plug, and
the waterproof plug is stored in the holding part.

7. The wiring member according to claim 6,
wherein a lock receiving part is provided at a base end of the cylindrical part, and
the fixed part has a protruding piece that extends from the holding part toward the main body along the extending direction, and a locking part that is provided on the protruding piece and locks into the lock receiving part.

8. The wiring member according to claim 3,
wherein a terminal is provided at an end of the first section of the electric wire,
a sheath is provided in the second section of the electric wire,
the molded part includes a part that serves as a connector housing for holding the terminal, and
an end of the sheath is separate from the waterproof plug and the retainer along the extending direction.

9. The wiring member according to claim 3,
wherein a plurality of the electric wires are provided,
a plurality of through holes are formed in the waterproof plug formed in a plate shape,
the electric wires pass through the plurality of through holes, and
an inner peripheral surface of each of the plurality of through holes is the second contact part.

10. The wiring member according to claim 6,
wherein a terminal is provided at an end of the first section of the electric wire,
a sheath is provided in the second section of the electric wire,
the molded part includes a part that serves as a connector housing for holding the terminal, and
an end of the sheath is separate from the waterproof plug and the retainer along the extending direction.
